(19) United States
(12) Patent Application Publication
(10) Pub. No.: US 2008/0196184 A1
(43) Pub. Date: Aug. 21, 2008

(54) Toothbrush with light source for illuminating oral cavity

(76) Inventor: Dooley Mary T., Virginia Beach, VA (US)

Correspondence Address: Bradley D. Goldizen, One Columbus Center, Ste. 665, Virginia Beach, VA, 23462, US

(21) Appl. No.: 12/070,030

(22) Filed: Feb. 14, 2008

Related U.S. Application Data
(60) Provisional application No. 60/901,477, filed on Feb. 15, 2007.

(51) Int. Cl. A46B 13/00; A46B 15/00; A46B 9/04; A61C 3/00; F21V 33/00

(52) U.S. Cl. 15/22.1; 15/105; 15/167.1; 433/29; 362/109

(57) ABSTRACT

A toothbrush apparatus includes a power source coupled to a light source for illuminating the oral cavity of the user to aid in the tooth cleaning process and prevent damage from inaccurate brushing. The light source is arranged away from the bristles and directs light towards the free ends of the bristles to aid the user in identifying areas of the teeth that may need more cleaning. In this manner, the user can more accurately clean all areas and prevent damage to the surrounding gum tissue, while directing appropriate brushing strokes to areas where food debris and plaque are present. The toothbrush may be provided in a manual or automatic version.

The present application claims priority from U.S. Provisional Patent Application Ser. No. 60/901,477 filed on Feb. 15, 2007.

This application did not receive any federal research and/or development funding.

### TECHNICAL FIELD

Generally, the present invention relates to dental hygiene devices for cleaning teeth. More particularly, the device relates to a toothbrush having a handle attached to an operating end which includes bristles. A light source is arranged between the operating end and the handle for directing light onto and illuminating tooth surfaces to aid in the brushing process. A power source, such as a battery, is arranged in the handle for providing power to at least the light source. In another embodiment, the power source provides power to both the light source and oscillating or rotating bristles. The light may be used with other tooth cleaning aids such as dyes to easily identify areas of the tooth surface that are not being properly brushed.

### BACKGROUND OF THE INVENTION

Toothbrushes are commonly used for brushing the teeth of the user. Toothbrushes come in a variety of shapes and sizes. There are manual and automatic types of toothbrushes. The manual type of toothbrushes includes a handle that is held by the user and a head with bristles. The user must repetitiously oscillate the bristles across the teeth. Automatic or electrically powered toothbrushes include a battery or other rechargeable power source for rotating the bristles. The bristles are placed on the teeth to be cleaned while the bristles rotate. Likewise, lights have been included in toothbrushes for bleaching teeth, fluorescing dyes, or for ornamental purposes.

U.S. Pat. No. 3,261,978 to Brenman discloses a dental cleaning apparatus that is a toothbrush having a handle with a switch mounted thereon. Light bulbs are mounted within the head for producing light having a wave length of 3650 angstroms to fluoresce a dye. In a further embodiment, the head includes a Lucite body having a polished portion to which bristles are attached for transmitting the light there through.

U.S. Pat. No. 6,886,208 to Kemp et al. discloses a toothbrush assembly having an environmentally safe polymer battery. A light source is molded into the handle with a polymer battery. Light from the light source is reflected along the length of the inner body by internal reflection. This light may enter the head and exit through the base of translucent tufts or bristles.

U.S. Pat. No. 6,106,294 to Daniel discloses a lighting toothbrush and method. A motion switch senses the motion of the lighting toothbrush and sends a closure signal to a timer which supplies a voltage waveform to a plurality of lights. The plurality of lights can be sequentially illuminated to produce a “twinkling effect.”

U.S. Pat. No. 4,779,173 to Carr et al. discloses an illuminated brush device having a head and a handle with a light source and source for energizing the light source. Plastic filaments have one end adjacent the light source and the other end disposed in and through the head such that light is transmitted through the filaments to the attached side of the bristles.

U.S. Pat. No. 6,623,272 to Clemans discloses a light-emitting toothbrush and method of whitening teeth. A head includes a plurality of bristles affixed thereto. A handle connects to the head. A light guide includes a first end disposed within the head and a second end disposed within the handle. A light source is optically connected to the second end of the light guide. The light source emits light having a spectrum ranging from about 350 nm to about 700 nm to accelerate a photo-bleaching process of whitening teeth.

None of the aforementioned patents work adequately for lighting the oral cavity of a user even when new. One major setback associated with some of the prior art is the attempt to transmit light through the head region which is difficult to achieve. As the bristles of the toothbrush begin to wear out, they become misshaped and misaligned. The wearing out of the bristles causes light transmitted from the head to diffuse or attenuate which tends to lead to shadows on the teeth. Likewise, the capturing of food particles or toothpaste within the bristles during the brushing process tends to diffuse any light being emitted through the bristles. Further, it does not illuminate the surrounding area so that accurate bristle placement and plaque removal can be achieved while brushing. This is critical to avoiding damaging the surrounding fragile gums or over brushing of exposed root surfaces, causing pain and irreversible damage.

Many people have misaligned teeth or teeth that fit tightly together which causes problem areas or areas that are difficult to clean. It is very difficult to adequately view these problem areas before or during the brushing process. This tends to cause one to inaccurately brush these particular areas in an attempt to remove food particles and plaque. Inaccurate brushing tends to cause recession of the gum surface, exposes roots of the teeth and reduces the thickness of tooth structure, such as cementum and dentin. Other problems associated with an inability to adequately view where the plaque, debris or food particles are located, include cavities and gum disease, which can result in damage leading to pain and eventual tooth loss.

### SUMMARY OF THE INVENTION

The present invention is a toothbrush that includes a handle attached to an operating end which includes bristles. A light source is arranged between the operating end and the handle for directing light onto and illuminating tooth surfaces to aid in the brushing process. A power source is arranged in the handle for providing power to at least the light source.

In a first embodiment, the toothbrush includes a normally open switch that when closed causes the light source to be illuminated. The switch may be a slide-type switch that is low profile. It should be noted that other types of switches may be utilized to implement the invention. The light source may be a light emitting diode (LED), light bulb with filament, or the like. The power source may be a disposable battery or a rechargeable battery for powering at least the light source. Otherwise, the toothbrush may include a cord and plug assembly for coupling the toothbrush to a power source such as alternating current for either powering the toothbrush or charging a power source that powers the toothbrush.

In another embodiment, the toothbrush includes a momentary switch that is normally open. When closed, the switch provides an input into a timer circuit that allows power to flow from the power source to the light source for a predetermined period of time. In this instance, the operational life of the power source is extended by ensuring that power to the light source is automatically turned off such that the light source is not inadvertently left on when not in use.

In a further embodiment, the power source provides power to both the light source and a motor for oscillating or rotating the bristles located on the operating end of the toothbrush. In this instance, the switch may be either a normally open switch that may be closed during use or a momentary switch that may provide a momentary signal input for timer circuitry that energizes the light source and the motor for a predetermined period of time. The control circuitry for controlling the rotating or oscillating bristles may include a double pole, triple position switch having a pair of contacts on the feed side of the switch coupled to the light such that the light source lights when the switch is not in the “off” position and in either of the “on” positions. Another feed contact supplies power directly to the motor when the switch is in a first position. The other feed contact supplies power to the motor through an impedance source such as a resistor which drops the voltage causing the bristles to slow down. Otherwise, the timer circuitry may be equipped with two separate inputs, each input coupled to a feed contact, such that power supplied through the switch routes through a voltage drop, such as a resistor or other impedance device, to reduce the speed at which the motor operates. This in turn, allows the oscillation or rotation of the bristles to be varied. Thus, in one position of the switch the light source is lighted and the bristles operate as a fastest speed; in a second position of the switch the light source is lighted and the bristles operate at a slower speed. Otherwise, the switch may be configured to just light the light in one position and operate the light and motor in another position.

Any of the aforementioned configured circuits may be utilized with either a manual toothbrush or an automatic toothbrush. Moreover, either the manual toothbrush or the electric toothbrush may include a replaceable head or operating end that engages the neck and handle in a detachable manner such that the head may be replaced when the bristles become worn. If the detachable head is used in a manual toothbrush, the head preferably includes a threaded region that mates with a complementary threaded region on the neck. If the detachable head is used in an automatic tooth, a drive shaft may include a drive gear arranged atop the drive shaft in a known manner. The teeth of drive gear mesh with teeth on a driven gear arranged in the detachable head to cause the bristles to be oscillated or rotated.

The light source is preferably arranged to direct light in a forward direction in front of and toward the free ends of the bristles. If the light source is a light bulb, it may include sides that are opaque and reflect light in a forward direction. Otherwise, the light bulb or LED may be arranged in a protective socket of the neck and may include reflective material to direct the light in a forward direction. The light source is arranged between the handle and the bristles for directing light in front of and toward the bristles such that the surface of the tooth may be examined and the bristles may be applied to the area that needs to be cleaned.

It is an object of the invention to illuminate the teeth while they are being brushed.

It is another object of the invention to provide a superior tooth cleaning brush that overcomes one's inability to accurately view the teeth during the brushing process to ensure that food particles, plaque and debris are removed during the tooth brushing process.

It is a further object of the invention to provide a toothbrush that significantly reduces pressure-induced recession of the gums and abrasion of exposed root surfaces from inaccurate placement of the bristles during the tooth cleaning process.

It an additional object of the invention to teach a device and method that reduces damage to the teeth caused by accumulated plaque and tartar, as well as reducing the pain and sensitivity in teeth which have been permanently and irreversibly damaged by toothbrush abrasion.

It is a further object of the invention to provide a toothbrush that allows a user to place brush where it is needed most and to more easily remove plaque, food particles and debris.

Additional objects and advantages of the invention will be set forth in part in the description that follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1 is a perspective view of a disposable manual toothbrush having a light source arranged therein.

FIG. 2A is a perspective view of a manual toothbrush with a replaceable head. FIG. 2B is a perspective view of the replaceable head detached from the neck of the toothbrush shown in FIG. 2A.

FIG. 3A is a perspective view of an automatic toothbrush with a detachable head. FIG. 3B is a perspective view of an automatic toothbrush with the detachable head removed. FIG. 3C is a cross section view of FIG. 3A.

FIG. 4A is a simplified schematic of the toothbrush of FIG. 1A and shows an LED light source. FIG. 4B is a schematic of the toothbrush of FIG. 1B showing a momentary switch coupled to a timing device for operating the lamp light source. FIG. 4C is an alternative schematic showing the light source in parallel with a motor for oscillating the bristles of the brush for use with the toothbrush shown in FIGS. 3A-3C. FIG. 4D is another schematic with a variable input to the motor to regulate the speed of oscillation of the bristles. FIG. 4E is a further schematic for implementing the circuit shown in FIG. 4D to variably control the input to the motor.

FIG. 5 shows the toothbrush being used to examine the teeth of a user.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

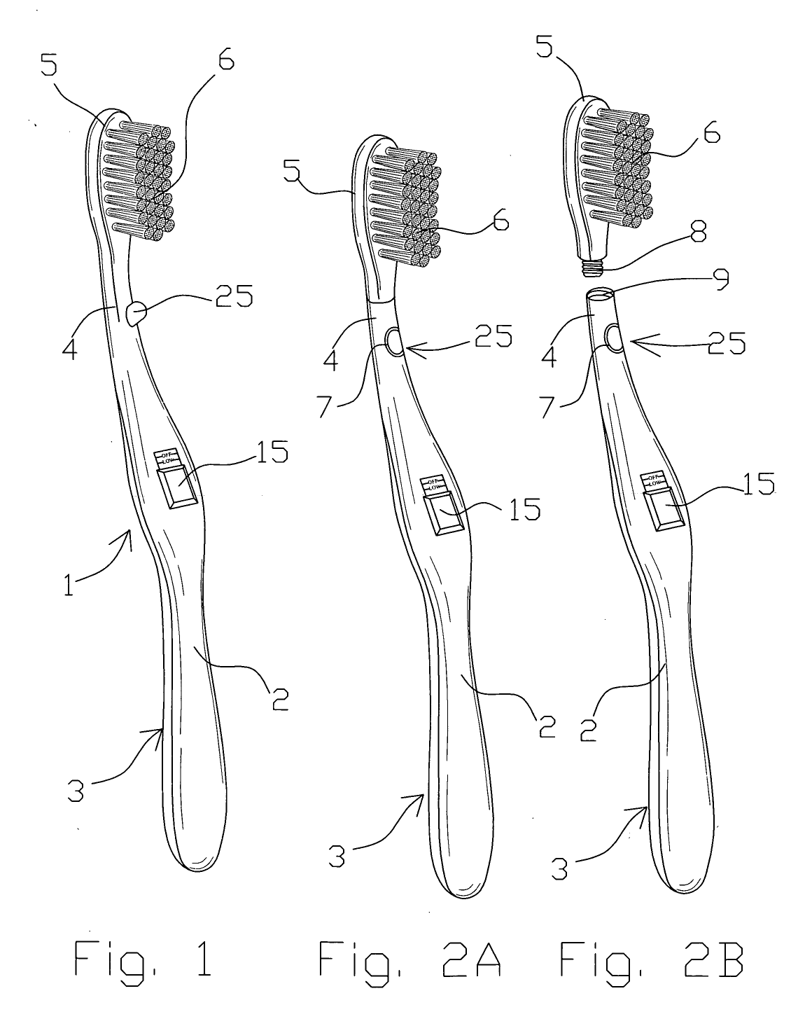

FIG. 1 is a first embodiment of the toothbrush and includes a toothbrush 1 that comprises a handle 2 that defines a power source compartment 3. The handle 2 connects to a head 5 via a neck 4. An opening extends from the power source compartment through which lead wires extend from the power source to the light source 25. Bristles 6 extend from a front side of the head 5. The light source 25 extends from a front side of the neck 4. The light source 25 may be angled to direct light emitted therefrom onto the free ends of the bristles and in front of them such that the toothbrush can be used to examine the teeth before, during or after brushing. A switch 15 is arranged on the handle 2 near the neck 5. When closed, switch 15 allows power to flow from a power source, not shown in FIG. 1, to the light source 25.

FIGS. 2A and 2B depict a manual toothbrush 1 that includes a detachable head 5. An externally threaded portion 8 extends from a bottom end of the detachable head 5 and mates with an internally threaded portion 9 arranged at an upper end of the neck 4. The neck 4 includes an opening 7 which has light source 25 arranged there behind. The opening 7 directs light towards a free end of the bristles 6. In this instance, the detachable head 5 may be replaced when it becomes worn out by turning it in a clockwise or counter clockwise manner depending on the angle of the threading.

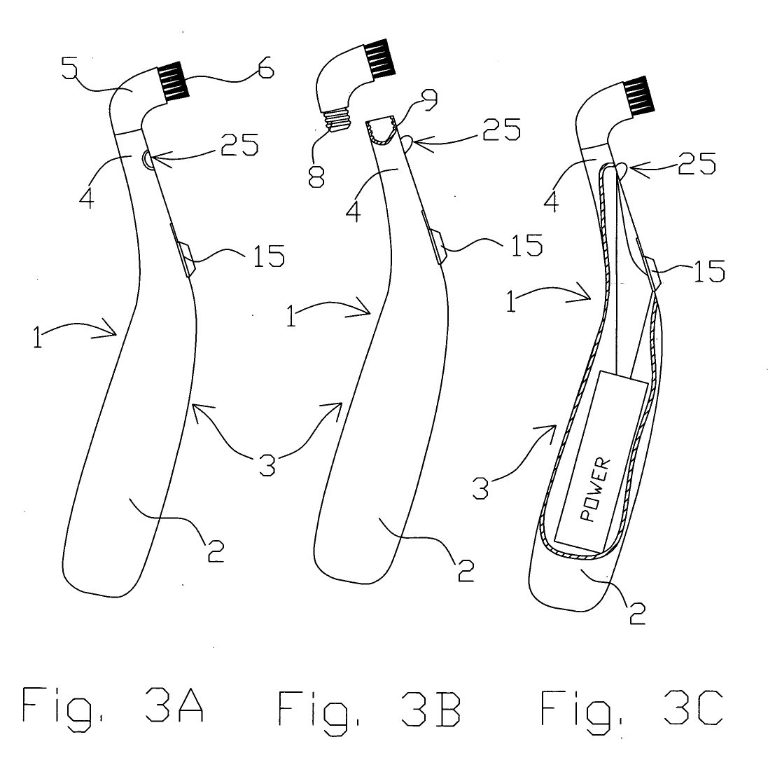

FIGS. 3A through 3C depict an automatic toothbrush in which the bristles 6 are rotated. The automatic toothbrush includes a detachable head 5 similar to the one shown in FIGS. 2A and 2B. A threaded portion 8 extends from the detachable head 5. An internally threaded region 9 mates with the threaded portion 8. For ease in understanding the invention, the portion that drives the bristles 6 is not shown. The bristles 6 may be rotated by a motor 30 arranged in the handle 2. Rotational energy from the motor 30 is preferably transferred to rotate the bristles 6.

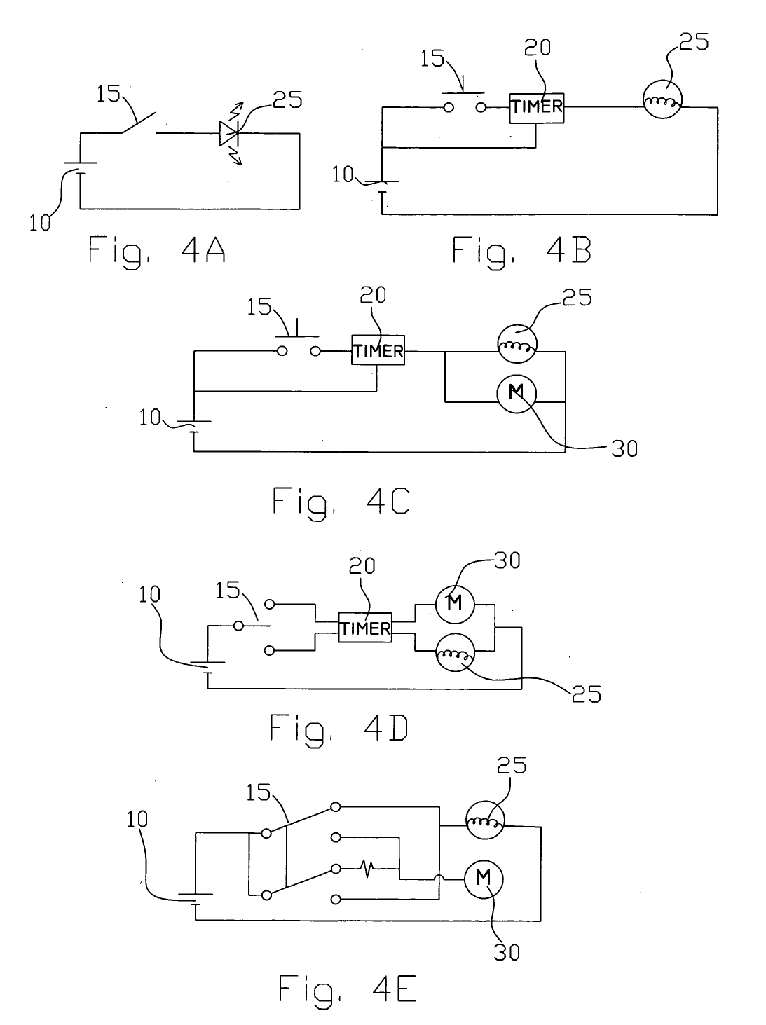

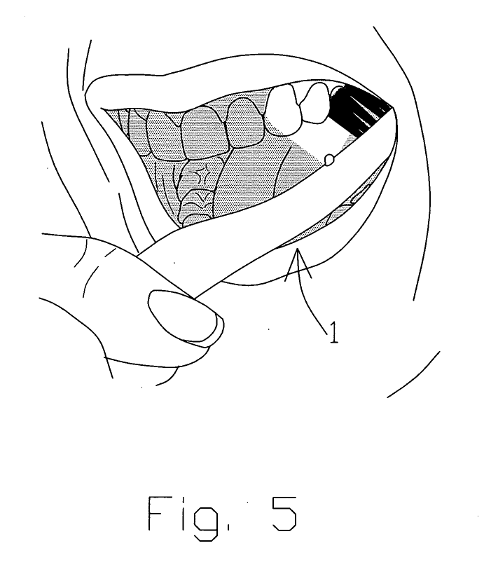

FIG. 4A shows schematic view of a simplified circuit and showing lead wires that connect the various components together. In this instance, a power source 10 supplies power to a normally open switch 15 that energizes light source 25. In this instance, the light source 25 is a Light Emitting Diode (LED) that emits light when in a conductive state. The LED may be arranged to extend from the front side of the neck 4 as shown in FIG. 1 and include metallized sides that direct light toward the rounded end of the LED. Alternatively, the LED may be arranged behind an opening 7, as shown in FIGS. 2A and 2B. The opening 7 may include a reflective material or be formed in a manner such that it directs the light emitted from the LED toward the free ends of the bristles 6.

FIG. 4B shows an alternative view of the schematic for operating the light source 25. In this instance, the light source 25 is a filament bulb and may be arranged as shown in FIGS. 1-2B. Switch 15 is preferably a momentary switch 15 that when activated turns on a timer 20 that powers the light source 25 for a predetermined period of time. The switch 15 comprises an input terminal and an output terminal as shown. The timer 20 is a known device and includes an input for receiving a signal from the switch 15 and an input for accepting power from the power source 10 and directing it to the light source 25 for a predetermined period of time. Thereafter, the timer 20 turns off the power supplied to the light source 25. This type of circuit is useful in preventing the wasting of power when the toothbrush 1 is not in use.

FIG. 4C shows another view of a schematic for operating the toothbrush 1 shown in FIGS. 3A-3C. A momentary switch 15 is arranged between the power source 10 and the timer 20. The timer 20 is preferably an integrated circuit chip having an input and an output. The timer 20 provides power to the light source 25 and the motor 30 for illuminating the light source 25 and rotating or oscillating the bristles 6 by powering motor 30. The transmission of rotation energy from the motor to the bristles may be realized in a known manner such as a drive shaft that extends from the motor to a gear connected to the bristles.

FIG. 4D shows is a schematic with a variable input to the motor to regulate the speed of oscillation of the bristles. In this instance, the switch 15 is a three position switch that is coupled to a timer 20 having two inputs. The timer includes two outputs and two feed contacts connected thereto, one output connects to the motor 30, the other output is coupled to the light source 25. In one position, the switch 15 is off and the light and motor are both in an off state. In a second position, the switch 15 is coupled to a first input to the timer 20. When the switch 15 is in the second position, the timer provides the full voltage value from the power source 10 to the motor 30 and the light source 25. When in the third position, the timer provides the full voltage value from the power source 10 to the light source 25, but a stepped down voltage of less than the full voltage value of the power source 10 is provided to the motor 30 to cause it to slow down. This in turn allows the bristle speed to be controlled.

FIG. 4E is a further schematic for implementing the circuit shown in FIG. 4D to variably control the input to the motor. In this instance, the switch 15 is a double pole, triple throw switch that includes two pairs of outputs. One pair of outputs is connected together and to the light source as shown. The other pair of outputs is connected together and to the motor as shown. An impedance source 75 is connected between the one of the outputs and the motor.

FIG. 5 shows the device of FIG. 1 being used to illuminate the teeth during the brushing process. The toothbrush may be used in brushing teeth. Thereafter, the user may rinse and examine her teeth by pulling the jaw away from the teeth using either a finger or the toothbrush as shown.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A toothbrush apparatus that illuminates an oral cavity of a user, said toothbrush apparatus comprising:
a head having bristles extending therefrom;
a hollow handle having a cavity;
a neck connecting the head to the hollow handle, said neck including an opening;
a power source arranged in said cavity of the hollow handle;
a light source arranged in the opening of the neck to direct light in front of the bristles such that the oral cavity is illuminated with light to aid the user in examining teeth before, during and after a brushing process has been performed on the teeth;
a switch coupled to the power source and the light source; and,
lead wires coupling said power source to the light source via the switch.

2. The toothbrush apparatus of claim 1 further including timer circuitry arranged in series with the switch to receive an input signal therefrom, said timer circuit energizing allowing power to flow from the power source to the light source for a predetermined period of time.

3. The toothbrush apparatus of claim 1 wherein said switch is a momentary switch.

4. The toothbrush apparatus of claim 1 includes a detachable head.

5. The toothbrush apparatus of claim 1 wherein said light source is a bulb having a filament or a light emitting diode.

6. The toothbrush apparatus of claim 1 further comprising a motor for oscillating or rotating the bristles, said motor coupled to the switch and in parallel with the light source.

7. The toothbrush apparatus of claim 6 further comprising a timer circuit arranged between the switch and the motor, said timer circuit having an input coupled to the switch and an output coupled to both the light source and the motor.

8. The toothbrush apparatus of claim 6 further comprising a timer circuit having a pair of inputs coupled to the switch and a plurality of outputs coupled to the motor and light source, the switch being a three position switch, wherein when the three position switch is in a first position the switch is in an off state, wherein when the three position switch is a second position the timer provides full power to the motor and light source, and wherein when the three position switch is in a third position the timer provides a lower voltage value to the motor than the voltage value provided to the light source.

9. The toothbrush apparatus of claim 1 wherein said switch is a double pole, triple throw switch having four feed contacts, two of the feed contacts connected to the light source, two of the feed contacts connected to the motor.

10. The toothbrush apparatus of claim 1 wherein said opening is an angled opening that aids in directing light toward free ends of the bristles.

11. A toothbrush apparatus that illuminates an oral cavity of a user, said toothbrush apparatus comprising:
a head having bristles extending therefrom connected to a hollow handle having a cavity via a neck, said neck including an opening;
a power source arranged in said cavity of the hollow handle;
a light source arranged on the opening of the neck to direct light in front of the bristles such that the oral cavity is illuminated with light to aid the user in examining teeth before, during and after a brushing process has been performed on the teeth;
a switch coupled to the power source and the light source; and,
lead wires coupling said power source to the light source via the switch.

12. The toothbrush apparatus of claim 11 further including timer circuitry arranged in series with the switch to receive an input signal therefrom, said timer circuit energizing allowing power to flow from the power source to the light source for a predetermined period of time.

13. The toothbrush apparatus of claim 11 wherein said switch is a momentary switch.

14. The toothbrush apparatus of claim 11 includes a detachable head.

15. The toothbrush apparatus of claim 11 wherein said light source is a bulb having a filament or a light emitting diode.

16. The toothbrush apparatus of claim 11 further comprising a motor for oscillating or rotating the bristles, said motor coupled to the switch and in parallel with the light source.

17. The toothbrush apparatus of claim 16 further comprising a timer circuit arranged between the switch and the motor, said timer circuit having an input coupled to the switch and an output coupled to both the light source and the motor.

18. The toothbrush apparatus of claim 16 further comprising a timer circuit having a pair of inputs coupled to the switch and a plurality of outputs coupled to the motor and light source, the switch being a three position switch, wherein when the three position switch is in a first position the switch is in an off state, wherein when the three position switch is a second position the timer provides full power to the motor and light source, and wherein when the three position switch is in a third position the timer provides a lower voltage value to the motor than the voltage value provided to the light source.

19. The toothbrush apparatus of claim 11 wherein said switch is a double pole, triple throw switch having four feed contacts, two of the feed contacts connected to the light source, two of the feed contacts connected to the motor.

20. The toothbrush apparatus of claim 11 further including motor control circuitry that steps down the voltage supplied to the motor.
